(19) United States
(12) Patent Application Publication
(10) Pub. No.: US 2023/0265903 A1
(43) Pub. Date: Aug. 24, 2023

(54) SHELL-BASED MATERIAL

(71) Applicant: THE ROYAL INSTITUTION FOR THE ADVANCEMENT OF LEARNING / MCGILL UNIVERSITY, Montréal (CA)

(72) Inventors: Abdolhamid Akbarzadeh SHAFAROUDI, Montreal (CA); Jiahao SHI, Sainte-Anne-De-Bellevue (CA); Hossein MOFATTEH, Montreal (CA); Armin MIRABOLGHASEMI, Montreal (CA); Gilles DESHARNAIS, Saint-Léonard (CA)

(21) Appl. No.: 18/111,306

(22) Filed: Feb. 17, 2023

Related U.S. Application Data
(60) Provisional application No. 63/312,176, filed on Feb. 21, 2022.

(51) Int. Cl. F16F 1/377

(52) U.S. Cl. CPC F16F 1/377; F16F 2230/36; F16F 2224/025

(57) ABSTRACT

A shell-based material, also referred to as a shellular or a shell-based mechanical metamaterial, is comprised of a plurality of unit cells that are each made of a curved shell, and contain at least one perforation on their snapping motif. The shell-based material has a predetermined number of structural stable states based on the snapping motif and on the at least one perforation. The predetermined number of structural stable states including a first structural stable state, for example an unloaded initial state, and a second structural stable state being different from the first structural stable state.

### CROSS-REFERENCE TO RELATED APPLICATION

The present application claims priority to U.S. Patent Application Ser. No. 63/312,176 titled “Shell-Based Material” and filed on Feb. 21, 2022, the entire contents of which is incorporated by reference herein.

### BACKGROUND

The design and fabrication of relatively low density materials with tailorable properties has attracted significant attention for a range of research and commercial applications. Such relatively low density materials may be used in applications in diverse fields including, and not limited to, load bearing materials, energy absorbers, dampers and deployable structures.

Despite this progress, there remains a need for relatively low density materials with tunable properties/functionalities capable of tolerating large forces and deformation without deterioration or failure. Therefore, improvements are desirable in the way relatively low density materials are configured for enhancing at least some of their mechanical properties.

### SUMMARY

Developing bistable metamaterials has recently offered a new design paradigm for deployable structures and reusable dampers. While most bistable mechanisms possess inclined/curved struts, a new 3D multistable shellular metamaterial is developed by introducing delicate perforations on the P shellular surface (as an example of triply periodic minimal surfaces), integrating unique properties of shellular materials such as high surface area, stiffness, and energy absorption with the structural multistability concept. Denoting the fundamental snapping part by snapping motif, certain shellular snapping motifs with elliptical perforations exhibit mechanical bistability. To bring the concept of multistability to a single snapping motif, we develop multistable shellular snapping motifs by introducing multilayer staggered perforations that form hinges and facilitate local instability. Adopting n-layer staggered perforation (n hinges) design can lead to a maximum 2ⁿ⁻¹ stable states within one shellular snapping motif during loading and unloading. Three-directional multistable shellulars are attained by extending the perforation design in three orthogonal directions. Harnessing snap-through and snap-back instabilities and self-contact mechanism, the introduced multistable perforated shellulars exhibit strong rigidity both in loading and unloading and enhanced energy dissipation. The introduced design strategy opens up new horizons for creating multidirectional multistable metamaterials with load bearing capabilities for applications in soft robotics, shape morphing architectures, and reusable and deployable energy absorbers/dampers.

In accordance with one aspect, there is provided a shell-based material including a plurality of interconnected unit cells, each unit cell including a continuously curved shell, the shell having at least one perforation defining a snapping motif on the shell. The shell-based material has a predetermined number of structural states based on the snapping motif defined on the shell of the unit cell and on the at least one perforation defined in the shell, the predetermined number of structural states including a first structural state, and a second structural state being different from the first structural state.

In some embodiments, each shell has a configuration of Schwarz P of alternative level set constants. In some embodiments, shells are designed based on alternative level set constants in the trigonometric equation for approximating Schwarz P.

In some embodiments, the at least one perforation includes an elliptical perforation.

In some embodiments, at least one of the unit cells is configured for supporting a predetermined load in a load direction, and a major diameter of the elliptical perforation extends along the load direction.

In some embodiments, the at least one perforation includes a plurality of multilayer staggered perforations.

In some embodiments, the predetermined number of structural states includes 2\hat{ }(n−1) structural states, wherein n corresponds to a number of layers of the multilayer staggered perforations.

In some embodiments, the multilayer staggered perforations include rectangular perforations.

In some embodiments, portions of the shell defining long sides of at least some of the rectangular perforations contact one another in response to the shell-based material supporting a predetermined compression load in a direction orthogonal to the long sides of the rectangular perforations.

In some embodiments, portions of the shell defining long sides of at least some of the rectangular perforations remain spaced apart from one another in response to the shell-based material supporting a predetermined compression load in a direction orthogonal to the long sides of the rectangular perforations.

In some embodiments, a section of the shell extending between adjacent staggered perforations defines a hinge, and the shell bends and twists about the hinge between the first structural state and the second structural state, the first and second structural states being consecutive structural states.

In some embodiments, the second structural state corresponds to a snap-back behavior of the unit cell.

In some embodiments, the second structural state corresponds to a snap-through behavior of the unit cell.

In some embodiments, the at least one perforation includes a first perforation extending along a first direction, and a second perforation extending along a second direction orthogonal to the first direction.

In some embodiments, the snapping motif is reproduced on the shell using rotation transformations about the first and second directions.

In some embodiments, the shell-based material has the first structural state and the second structural state along the first direction, and further has a third structural state being different from the first and second structural states, and a fourth structural state being different from the first, second and third structural states. The third and fourth structural states are along the second direction.

In some embodiments, the at least one perforation further includes a third perforation extending along a third direction orthogonal to the first and second directions.

In some embodiments, the shell-based material is formed of at least one of a thermoplastic polyurethane, a rubber-based material and a silicon-based material.

In some embodiments, at least one of the first and second structural state is a stable structural state.

In some embodiments, there is provided a damper including the shell-based material as described above.

In some embodiments, there is provided a shell network including shell-based material as described above.

Many further features and combinations thereof concerning the present improvements will appear to those skilled in the art following a reading of the instant disclosure.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Reference is now made to the accompanying drawings, in which:

FIG. 1A shows a half-cell of perforated P shellular metamaterial that can exhibit two stable states, when four sides are fixed and the pressure/force is applied on the top surface;

FIGS. 1B and 1C show that the force displacement curve of half-cell of intact P shellular with f=0 shows snap-through behavior while the perforated counterpart can be engineered to present mechanical bistability, indicated by the negative sign of their reaction force F;

FIG. 1D shows geometrical parameters of the designed perforated P shellular unit cells, with five samples with different level set constants f, perforation sizes a and b, and thickness t;

FIG. 1E shows the effect of level set f and shell thickness t/S on the bistability of perforated and intact shellulars, investigated by Finite Element (FE) simulation;

FIG. 1F shows an abstract spring model for the theoretical analysis of perforated shellulars;

FIGS. 1G and 1H show phase diagrams for the mechanical response of spring model under uniaxial compression in the parameter space (h/S, t/S) and (h/S, W1/W2) showing monotonic monostable, snap-through monostable, and bistable region;

FIGS. 2A and 2B show experimental (loading area is in the upper portion of the graph and unloading area is in the lower portion of the graph) and FE simulation (black solid line) stress-strain curves for samples I and III;

FIG. 2C shows a spring model for tessellated perforated shellular;

FIGS. 2D and 2E show contour of normalized snapping force Fₘₐₓ and effective stiffness Kₑ in the parameter space (h/S, K₁/K₂) for a spring subunit, representing a snapping motif of the perforated shellular;

FIG. 2F shows influence of level set constant f on normalized Kₑ and Fₘₐₓ of perforated shellular snapping motifs with the same thickness and perforation size;

FIG. 2G shows influence of level set constant f on normalized Fₘₐₓ with the same Kₑ and perforation size;

FIG. 2H shows experimental results of 3D printed graded perforated shellulars with the same thickness;

FIG. 3A is a schematic view showing a portion of the shellular p with multilayer perforations in a staggered configuration;

FIG. 3B shows representative deformation pattern and stress-strain curve of the designed multistable mechanical metamaterial during the loading and unloading;

FIG. 3C shows flexible bending-torsion induced bistable element, representing the deformation mechanism of staggered perforation layer, and the corresponding simplified spring model consisting of compressive and torsional springs;

FIG. 3D shows contour of normalized snapping force, Fₘₐₓ, with respect to flexible beam length, Lₜ, and width, W_{b};

FIG. 3E shows four stable states of sample M-II during loading and unloading;

FIG. 3F shows experimental and numerical simulation for stress-strain curve of 3D printed sample M-II;

FIG. 3G shows potential and dissipation energy versus strain for sample M-II, obtained by simulation;

FIG. 4A shows five 3D printed half cells of multistable perforated shellular metamaterials, and numbers in parenthesis indicate the number of stable states including the initial configuration;

FIG. 4B shows a contour associated with the number of stable states (table on the left), maximum snap-back induced energy dissipation (table in the middle), and total snap-back induced energy dissipation during a cyclic load (table on the right) with respect to the circumferential angle α and flexible beam height t′, determined by FE simulation;

FIG. 4C shows experimental and FE simulation of stress-strain curve of the developed multidirectional multistable perforated shellular unit cell under uniaxial tension and compression along with five stable states of the perforated shellular unit cell during tension that have been highlighted;

FIG. 4D shows 3D deployment of multidirectional multistable unit cell;

FIG. 4E shows load bearability of an ensemble of 3×1×1 cells of the designed multidirectional multistable perforated shellular material under tension at selected stable configurations when exploited to hold a 1 kg mass;

FIG. 4F shows a 3×3×3 multidirectional multistable perforated shellular metamaterial with fully packed, fully unpacked, and a selected number of intermediate transitional stable states;

FIG. 5A shows the influence of perforation width on the self-contact mechanism of multilayer perforated P shellular;

FIG. 5B shows quasi-static compression-tension test on 2×2×1 intact P shellular, Kelvin, no self-contact P shellular, and self-contact P shellular materials;

FIG. 5C shows low-velocity impact test by dropping a 917.8 g mass from a height of 81 mm;

FIG. 5D shows damping performance of four shell-based materials when impacted by a moving electric car, with arrows presenting the direction of forward (before impact) and rebound (after impact) motions;

FIG. 6 shows the design evolution for introducing perforation on the shell surface of material to develop shellular metamaterials with predetermined and programmable different stable states;

FIG. 7A is a close-up view of a shell having multilayer staggered perforations being under compression, with the long sides some of the perforations self-contacting one another;

FIG. 7B is a close-up view of a shell having multilayer staggered perforations being under tension, with the long sides some of the perforations self-contacting one another;

FIG. 8A is a schematic view showing a portion of a multistable shell-based material, with geometrical parameters thereof;

FIG. 8B shows geometrical parameters used for designing four samples;

FIG. 8C shows four cases of bi/multistable perforated shellulars;

FIG. 8D shows a comparison of force displacement curves of case I and case II of FIG. 8C for programming deformation sequences in multiple perforated shellulars;

FIG. 8E shows perforated shells with the patterns of case I and case II of FIG. 8C; and

FIG. 8F shows the increase in the number of stable configurations by adding more staggered perforation layers.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of the present technology.

The expression “shell-based material” refers to a material having a shell structure or a plurality of shell features. The shell structure or plurality of shell features may be arranged as a shell network or lattice. In the context of the present technology, the term “shellular” (being the blend of the terms “shell” and “cellular”) is used interchangeably with “shell-based material” and “shellular metamaterial”.

The expression “perforated shell” refers to an element or portion of a shell-based material having at least one internal lumen, cavity or void space defined by one or more walls forming the shell, such as walls resulting from one or more outer layers. Walls defining a shell may have a constant or a variable thickness. In some embodiments, the cavity may be a borehole and not extend throughout the wall defining the shell. A shell may have a spherical, cylindrical or other hollow structure which can be in the form of triply periodic minimal surfaces (TPMS), like Schwarz P, Schwarz D and Gyroid. As used herein, a “thickness” of a shell corresponds to a thickness of a wall of the shell.

The expression “shell network” refers to an arrangement or structure of a shell or plurality of shells that are connected. In some embodiments, a shell network is a continuous arrangement or structure of a shell or plurality of shells. In some embodiments, a shell network is a smoothly varying arrangement or structure of a shell or plurality of shells, and optionally wherein features are physically interconnected and/or fluidly connected. Shell networks of some aspects are characterized by a non-periodic spatial distribution of shells, for example, where shells are provided in an anisotropic spatial distribution in one or more directions. In some embodiments, the internal cavities or internal volume of a shell network are in fluid communication through, for example, perforations defined in the shells. Optionally, the shell network is non-periodic and is not a lattice. In some embodiments, the shell network or shell-based material is deterministic, and the arrangement or geometry of the shell network is predetermined. In some embodiments, the magnitude of curvature, average thickness, characteristic length, and/or average density of one or more shells are predetermined.

A deterministic material, network, or structure is custom engineered to be useful for a specific application, where the specific functionality is determined by one or more features or properties of the material, network, or structure. The term “deterministic” refers to a material, network, or structure characterized by at least one deterministic feature or property, which is predicted and controlled to be substantially equivalent to at least one predetermined feature or property. A “predetermined” feature or property, or value(s) thereof, is the feature or property as determined or selected prior to the formation of the structure. In some examples, the shells possess thicknesses ranging from tens of micrometers to centimeters, and are characterized by curvatures and lack of sharp edges which enhances at least some mechanical properties. In other words, the surface forming each shell can have in some embodiments a zero mean curvature at any point of the surface when shellular materials are made by TPMS.

The expression “monostable” refers to one structurally stable configuration. The expression “bistable” refers to two structurally stable configurations. The expression “multistable” refers to more than two structurally stable configurations. These expressions refers to structural states of the perforated shell-based material in which the material is in a configuration capable of keeping its topology and macroscopic structural configuration. At stable configurations, materials/structures are at local minima of the elastic potential energy and no external forces/constraints are needed to keep the materials/structures at these stable states. These reconfigurable multistable materials/structures commonly switch among stable configurations by elastic buckling or snapping. For example, an umbrella can have the shell surface thereof everted from one stable state to another in a strong gust of wind, or a contact lens can be configured from one stable state to another when being everted inside out.

Generally described, as a class of artificial materials, metamaterials exhibit unprecedented properties that are hardly found in current naturally occurring materials (e.g., negative refractive index, negative incremental stiffness, negative Poisson's ratio, and apparent negative thermal conductivity), mainly emanated from their underlying rationally-designed architectures rather than the intrinsic attributes of their constitutive materials. Tailoring multiphysical properties of metamaterials and making them adaptable to the changing requirements of real-life applications as multifunctional materials, demand for programmability. Utilizing reconfigurable mechanical metamaterials can offer a reliable solution to render programmable properties, such as tunable acoustic and photonic bandgaps, for performance tuning of advanced materials on demand. Structural multistability enables achieving large deformation by harnessing elastic instability and retaining different stable configurations without an external load. Additionally, with recent advances in 3D/4D printing, structural multistability provides a new pathway for shape reconfiguration, shock isolation, reusable energy absorption, and rapid response actuation. Therefore, developing next generation of multistable mechanisms imparts new routes for programming multifunctional and adaptive architected metamaterials.

Featuring two structurally stable states, bistable mechanical metamaterials are marked by their unique local minima of the elastic potential energy and exhibit snap-through/back behaviors with negative incremental stiffness. The bistable section/segment in most of these rationally-designed materials are comprised of two pivotal elements, i.e. constrained inclined or curved beams and 3D shallow domes. Structural multistability can be realized by assembling these bistable elements in a form of 1D chains, 2D planar/cylindrical sheets, or 3D lattices. By tailoring the topology of their underlying architectures, a series of multiphysical properties (e.g., elastic waves band gaps, strain energy entrapment, thermal expansion coefficient, and Poisson's ratio) of the bi/mulistable metamaterials can be tuned. Rapid shape changing triggered by external stimuli (e.g., water or solvent content and temperature change) is also viably realized in mechanical metamaterials fabricated by passive constitutive solids. Several design strategies for structural bi/multistability, including but not limited to creased cones, foldable origamis, waved sleeves, compliant hinges, multiple magnetic system, and integrated granular particles and compliant stretchable components, have also been proposed for developing deployable structures with improved stiffness and durability. The snapping motifs or building blocks of these metamaterials (i.e. the fundamental region of the cell, which has more than one stable state, and from which the whole architecture can be built using various transformations) generally switch only between two stable configurations and multistability is achieved by utilizing an assembly of these bistable blocks. Exploiting 3D snapping motifs with arbitrary stable configurations facilitates the realization of the redeployable structures with multiple configurations and soft robots with a plethora of controllable displacement degrees of freedom.

Due to their highly nonlinear deformation behavior caused by their intriguing structural instability, elastic shells can be invoked to design multistable unit cells for mechanical metamaterials that can adapt themselves to loading conditions. Conventional bistable or tristable shells (e.g. half tennis ball and Venus flytrap) display buckling and snapping configurations, determined by their curvature, prestress, and residual stress. In addition, surface patterning, like corrugation or varied thickness surfaces, can impose structural multistability in elastic shells. Although shells may serve as a promising design platform for discovering new structural elements, their complex nonlinear deformation modes and challenges associated with their tessellation to form mechanical metamaterials have impeded their applications in advanced multistable material design. Based on polyhedron templates and high degrees of freedom of hinges, assembled prismatic metamaterials can exhibit multistable behavior along multiple directions; nevertheless, to the best of authors knowledge, none of the existing polyhedron-based multidirectional multistable cells can achieve simultaneous stable states along different directions, as their multidirectional stable states are not independent of each other, and the realization of a new stable state in one direction can break the multistability in other directions.

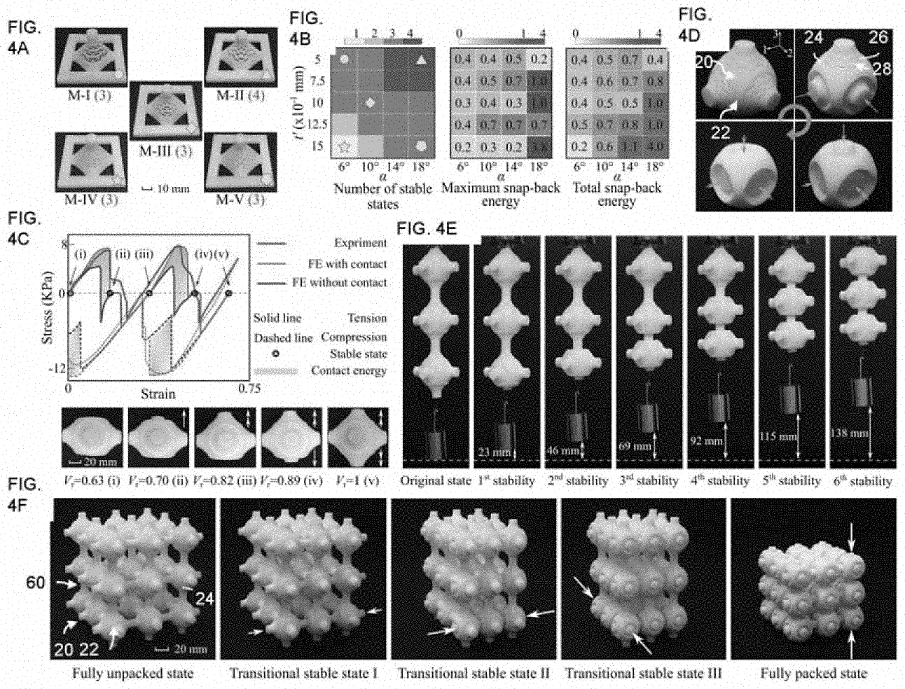

As a new type of architected materials, shell-based materials or shellulars are composed of a network of 3D unit cells of curved thin shells. With less sensitivity to stress concentration and architectural defects than truss and plate based cellular solids, some shell-like metamaterials have shown promising potentials for achieving enhanced stiffness and strength. While shellular metamaterials can be formed by any non-self-intersecting shell surface, they are commonly developed based on triply periodic minimal surfaces (TPMS), e.g. Schwarz P (Primitive) (FIG. 4D), Schwarz D (Diamond), and Gyroid, in which, triply periodic refers to periodicity in three directions and minimal surfaces represents a locally minimum surface area for a given boundary. TPMSs are intersection-free smooth surfaces with zero mean curvature at any point and they partition the space into two independent but intertwined continuous sub-volumes. The geometric features of TMPSs hold great promise for creating shellular materials with unrivaled multifunctional properties, such as minimal stress concentration, high fluid permeability, and enhanced heat transfer, for a wide range of applications in bionic scaffold, catalytic converters, heat exchanger, ultrafiltration, and microbatteries. Although the rapid snapping and fast closure of Venus flytrap in the nature exemplifies the bistability of shell-like architectures, structural bi/multistability of shellulars with complex architectures are yet to be discovered. There is presented a novel design and manufacturing route for realization of programmable and previously inaccessible deployable multistable perforated shellulars that can unveil desired number of stable states in their snapping motifs, (from monostable to multistable), supported by experiments demonstrating multistable cells including those with quadstable motifs.

The multistable design concept is implemented on the Schwarz's Primitive (P) surface of shellulars through exploiting two perforation strategies: (1) elliptical perforations along the loading direction (as bistability pattern); and (2) staggered rectangular perforations orthogonal to the loading direction (as multistability pattern). By engineering the geometrical parameters of the P shellular and the selected perforation profiles, we demonstrate how bistability can be achieved in P shellular snapping motifs with elliptical perforations, while the staggered perforations can lead to tri/quad/multi stability. Numerical simulation, theoretical spring modelling, and mechanical testing are conducted to study the structural multistability of the introduced perforated P shellular metamaterials. Furthermore, the perforated snapping motifs are employed to design and manufacture 3D unit cells that exhibit decoupled shape reconfigurations and multistable load-bearable configurations, under both tension and compression, along three distinct orthogonal directions. The introduced design framework offers a new paradigm for realization of reconfigurable advanced materials in the form of programmable shell-based multistable mechanical metamaterials for potential applications as soft robotic grippers/muscles, actuators, reusable energy absorbers, and adaptive structures.

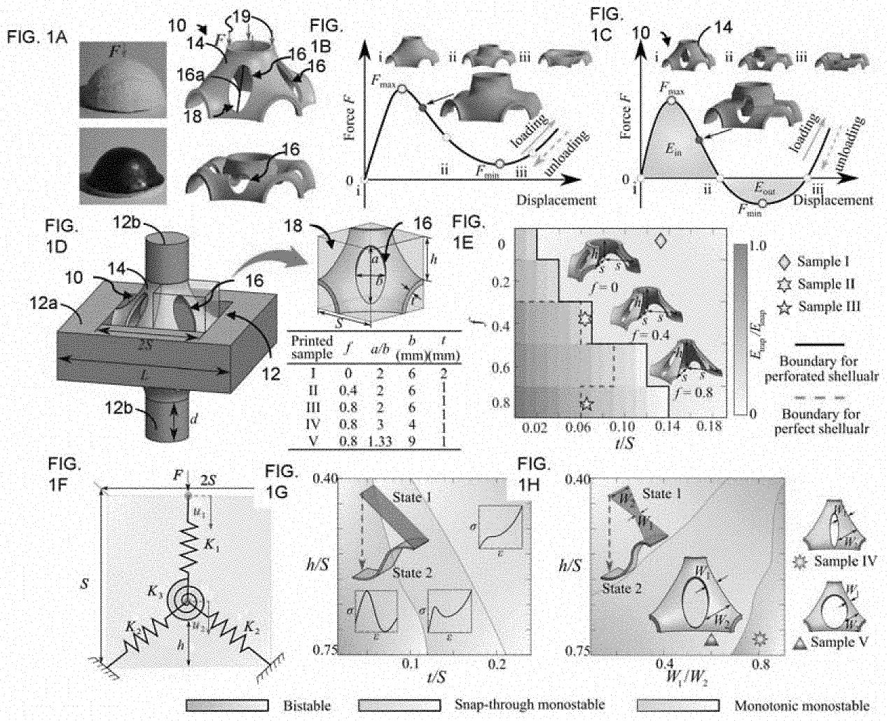

FIGS. 1A, 10 and 1D show examples of a shell-based material 10 having one unit cell 12 including a shell 14. The shell 14 has elliptical perforations 16 defined therein. The perforations 16 define a snapping motif 18 on the shell 14. The snapping motif 18 is shown in isolation in FIG. 1D. The unit cell 12 is configured to support a predetermined load F in a load direction represented by arrows 19 (FIG. 1A). Each elliptical perforation 16 is defined in the shell 14 to have a major diameter 16a thereof (FIG. 1A) extending generally along the load direction represented by arrows 19. In other words, in this example, as the load direction 19 is vertical, the elliptical perforations 16 have their major diameter 16a extending generally vertically so as to facilitate the unit cell 12 from passing from one structural stable state to another structural stable state, as shown in FIGS. 1A and 10.

Referring to FIGS. 1A to 10, unit cells 12 of perforated shellular metamaterials 10 with bistable snapping motif are designed by adding perforations 16 through an intact Schwarz P shell 14. In other embodiments, the shellular metamaterials 10 could be configured as a Schwarz D, Gyroid, or comprised of any other suitable shell network. The mid-surface of the P shellular surface is mathematically defined by cos(x)+cos(y)+cos(z)=f, where f is level set constant that varies from 0 to 1. The proposed bistable mechanism in this study finds inspiration from the bistability of a spherical cap, similar to the shell surface eversion of an umbrella in a strong gust of wind or a contact lens when being inside out. The unit cells 12 of designed perforated P shellular metamaterials 10, as a family of thin shells and inclined beams, can exhibit a bistable behavior with symmetrically deformed perforated segments under compression applied on their top surface; fixed boundary conditions are assigned to the four side surfaces (FIG. 1A). Negative incremental stiffness is observed in the compressive stress-strain curves for both intact (FIG. 1B) and perforated (FIG. 10) half-cells when a compressive force reaches Fmax. However, upon unloading, the intact shellular part returns to its original stable state (state i in FIG. 1B) and merely presents a positive non-initial minimum force Fmin>0, demonstrating a monostable snap-through behavior. In FIG. 10, the half-cell of perforated shellular 10, in contrast, restores the state iii and holds two stable states (states i and iii) and exhibits bistable behavior. In the following analyses, we use the ratio of Eout, due to the second stable configuration, and Ein, energy required for material instability in the unloading and loading, respectively, to assess the structural bistability of perforated shellular unit cells 12 and to evaluate their potentials for absorbing and trapping energy.

FIG. 1D shows our perforated shellular unit cell 12, where a solid frame 12a is used to fix the displacement of shell sides and the two cylindrical bars 12b at the top and bottom limit the local shell deformation. The elliptical perforations 16 are located at the center of eight evenly divided shellular segments at the upper and lower half cells along the cylindrical bars 12b. To evaluate the relationship between geometrical parameters and structural bistability, five samples (FIG. 1D) with three replicates and alternative level set constants (f), ellipse sizes (a and b), and surface thickness (t) are 3D printed by Selective Laser Sintering (SLS) out of thermoplastic polyurethane (TPU). The unit cell size is 5 cm×5 cm×5 cm with frame length L, as 5 cm, shellular size 2S, as 3 cm, and cylinder bar height d, as 1 cm. It is contemplated that the shell-based material 10 could be made of other flexible materials such as, and not limited to, a rubber-based material and/or a silicon based material or any other suitable material, such as metals and ceramics. It is also contemplated that the shell-based material 10 could be made of any other suitable material, such as metals and ceramics. While the viscoelasticity of TPU causes energy dissipation through the rate dependent deformation and the rate independent snap-back, the bi/multistability of our rationally-designed perforated shellulars is not originated from the viscoelastic energy dissipation of the constituent material, since the stable states are defined based on the quasi static response of the designed architectures, requiring sufficient resting time for the base material to reach steady state equilibrium.

The influence of level set constant f and relative thickness t/S on the response of perforated shellular unit cells under uniaxial compression is also investigated by finite element (FE) simulation under a quasi-static condition. As reflected in FIG. 1E, snap-through and bistable behaviors of the half-cells of the designed metamaterials 10 highly depend on the assessed architectural parameters. In specific, increasing the level set constant f or decreasing relative thickness t/S, leads to stronger bistability, indicated by a phase transition boundary (solid black line) and a high Eout/Ein (darker areas). For example, for a small level set constant and a high relative thickness (f=0, t/S=2/15), both numerical and experimental results approve the monostable snap-through behavior for sample I, while samples II (f=0.4, t/S=1/15) and III (f=0.8, t/S=1/15) present bistable behavior with energy trapping capabilities. Although we have observed a bistable domain for the half-cell of intact P shellulars (enclosed by dashed lines in FIG. 1E), introducing perforations 16 on the P shellular remarkably expands the bistable region, offering bistability for a wide range of f from 0 to 0.8. The smaller bistability region for the intact shellular is thought to be due to the relatively higher circumferential stiffness of the intact shellular; the constrained circumferential expansion under compression can lead to shell wrinkling that prevents symmetrical deformation and results in a global buckling of the shellular.

To better understand the underlying mechanics of the observed mechanical behaviors in the experiments and FE simulations, a theoretical model of a half-cell consisting of pin jointed compressive (K1 and K2) and torsional (K3) springs is developed (FIG. 1F). As a simple mathematical model of the geometric motif of the designed shell-based unit cell in FIG. 1D, K1 spring stands for the rigid cylindrical bar 12b with stiffness assumed as infinite compared to the compliant shellular 10; the displacement of flexible segments is divided into bending and compression components, represented by torsional (K3) and compressive (K2) springs respectively. Therefore, counteraction between K2 and K3 springs determines the bistability of perforated shellulars 10. As depicted in FIG. 1F, the sign of the reaction moment from K3 spring (i.e. the bending moment of the shell) remains unchanged under compression, making it serve as a recovering force that always pushes the perforated unit cell to retain its initial state. On the contrary, the sign of reaction force direction of K2 spring varies during the deformation; when displacement u2 is beyond h, the opposite direction of reaction force from K2 springs along the vertical displacement provides a possibility to achieve new stable states. In extreme cases of ultrathin shellulars with negligible bending stiffness K3, the spring system always holds two stable configurations at u2=0 and u2=2 h.

By simplifying the curved perforated shellulars with an inclined straight plate and determining its corresponding stiffness K2 and K3 (assuming an infinite stiffness for K1) in FIG. 1F, we can distinguish three different mechanical behaviors, i.e. bistable, snap-through monostable, and monotonic monostable, based on different combinations of h/S and t/S. Since K2 spring stiffness shows a linear relationship with shell's thickness (t) and K3 spring stiffness has a cubic relationship, increasing the shellular thickness has more considerable influence on K3 spring than K2. Therefore, decreasing t/S transforms the response of the perforated shellular snapping motif 18 from a monotonic or snap-through monostable to a bistable one. Meanwhile, higher h/S (corresponding to larger level set value f) creates longer shell segments between the perforations, which has no effect on their simplified compressive stiffness K2 and it only reduces their bending stiffness K3, increasing the magnitude of the maximum negative force and resulting in higher energy trapping through the bistable behavior. Since increasing f leads to a higher h/S (as shown by the representative half-cell of shellulars with different fin FIG. 1E), the proposed spring model well explains the trends found in FIG. 1E, where a smaller t/S or a higher h/S is desirable in the bistable region. In order to better elicit the effect of elliptical perforation shapes on the mechanical behavior, FIG. 1H uses an inclined trapezoidal plate (instead of the previously assumed rectangular shape), to represent the perforated shellulars. The model shows that a higher a/b or a smaller W1/W2 is desirable for bistable architectures, a conclusion that has been validated by conducting experiments on 3D printed samples IV and V. The stiffness K2 and K3 of the straight and trapezoidal plates in the presented simplified model are related to the geometrical features of shellular segments.

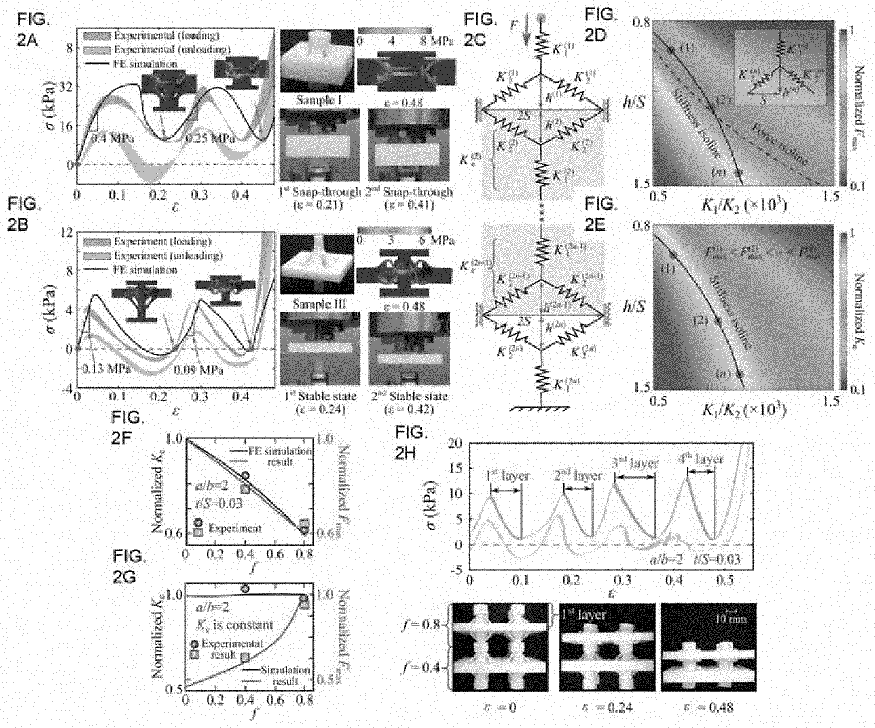

FIGS. 2A and 2B show the stress-strain curves and deformation modes of the 3D printed samples I and III through experimentation and FE simulation. Two non-initial positive local minima for stress during loading indicate the monostable snap-through behavior of sample I. Meanwhile, sample III demonstrates snap-through and tristable response with three stable states at ε=0, 0.24, and 0.42. The different mechanical responses of the two samples I and III confirm the reliability of the proposed simple spring model in detecting mechanical bistability. As shown in FIG. 1G, increasing h/S or f and decreasing t facilitate the bistability of perforated shellulars. The agreement between numerical and experimental results corroborates the accuracy of the numerous FE simulations carried out for preparing FIG. 1E.

Although samples I and III in FIGS. 2A and 2B deform in a layer-by-layer manner, due to the uniformity of topological features of the two layers (top and bottom shell), the deformation sequence is uncertain and is mainly governed by the geometrical imperfections of the 3D printed samples and the boundary conditions imposed by the testing machine's fixture. A heterogeneous design of perforated shellulars, in which the architectural parameters of neighboring snapping motifs are distinct, can overcome the indeterminacy of deformation sequence of metamaterials made by tessellation of unit cells to offer designing mechanical metamaterials with controllable configurations. In FIG. 2C, a connected pin jointed spring system in series is built to represent the assembly of the perforated shellular units, where Kₑ⁽ⁱ⁾ represents the effective stiffness of i^{th} snapping motif (i=1, 2, . . . , 2n, where Kₑ⁽ⁱ⁾ represents the effective stiffness of i^{th} snapping motif, and n represents the number of unit cells each containing 2 snapping motifs) of the spring system consisting of K₁⁽ⁱ⁾ and K₂⁽ⁱ⁾ springs. Focusing on thin shells with small bending stiffness, the rotational spring K₃⁽ⁱ⁾, presented in FIG. 1F, is neglected in this model. Since under quasi-static deformations, the forces within all subunits are equal to the external force F, snapping motifs with a lower critical/snapping force deform first, indicating that the magnitudes of their Fₘₐₓ determine the deformation sequence of the simplified spring system and its corresponding assembly of bistable units.

FIGS. 2D and 2E present the contour of the snapping force Fmax and effective stiffness Kₑ (both normalized by their respective maximum values) in the parameter space (h/S, K1/K2) for a spring subunit. Even though increasing both h/S and K1/K2 leads to smaller normalized Fmax and Ke, the two contour plots show different patterns, i.e. negative curvature of force isoline (dashed line in FIG. 2D) and positive curvature of effective stiffness isoline (solid line in FIG. 2D). Therefore, based on the force isoline, we can program multilayer perforated shellular metamaterials with a desired overall stiffness and deformation sequence (programmable architectural configuration), in which the points in the stiffness isoline satisfy Kₑ⁽¹⁾=Kₑ⁽²⁾= . . . =Kₑ⁽ⁿ⁾ while Fₘₐₓ⁽¹⁾<Fₘₐₓ⁽²⁾<Fₘₐₓ⁽²⁾< . . . <Fₘₐₓ⁽ⁿ⁾.

An approach for realizing deployable perforated shellular metamaterials 10 and meta-structures with deterministic deformation configuration is to vary the level set constant f of the perforated shellular segments of the adjacent unit cells 12. As shown in FIG. 2F, for a given shellular thickness (t/S=0.06) and perforation geometry (a/b=2), both effective stiffness Ke and snapping force Fmax exhibit a decreasing trend by increasing the level set constant f. As a result, if we make an assembly of heterogeneous perforated shellular unit cells 12 with the same thickness and perforation size but with dissimilar level set constants, the deformation sequence occurs in a reverse order with respect to f value, since Fmax(f=0)>Fmax(f=0.2)> . . . >Fmax(f=0.8). Similarly, for a predefined value of level set constant and perforation size, increasing the shellular thickness leads to a higher effective stiffness and snapping force, and consequently, reconfiguration begins from the thinnest subunits among the snapping motifs.

Constant effective stiffness during shape reconfiguration is desired to realize robust multiphysical properties, such as blocking specific wave propagation in phononic metamaterial. FIG. 2G provides the relationship between snapping force Fmax and level set f for a perforated shellular snapping motif with a predefined effective stiffness and perforation size, in which Fmax monotonically increases when f increases. Therefore, in contrast to FIG. 2F, the deformation sequence that is directly associated with Fmax shares the same order with f, i.e. snapping motifs with smaller level set constant deform first.

In order to validate the proposed scheme for controlling deformation sequence, perforated shellular samples containing 2×2×2 cells (three replicate for each design) are designed and 3D printed based on samples II and III (introduced in FIG. 1D), and the experimental test results are presented in FIG. 2H. Based on the magnitude of maximum snapping force/stress, the deformation sequence of the perforated shellular metamaterial starts from sample III and then is propagated to sample II with snapping stresses at approximately 10 kPa and 13 kPa, respectively.

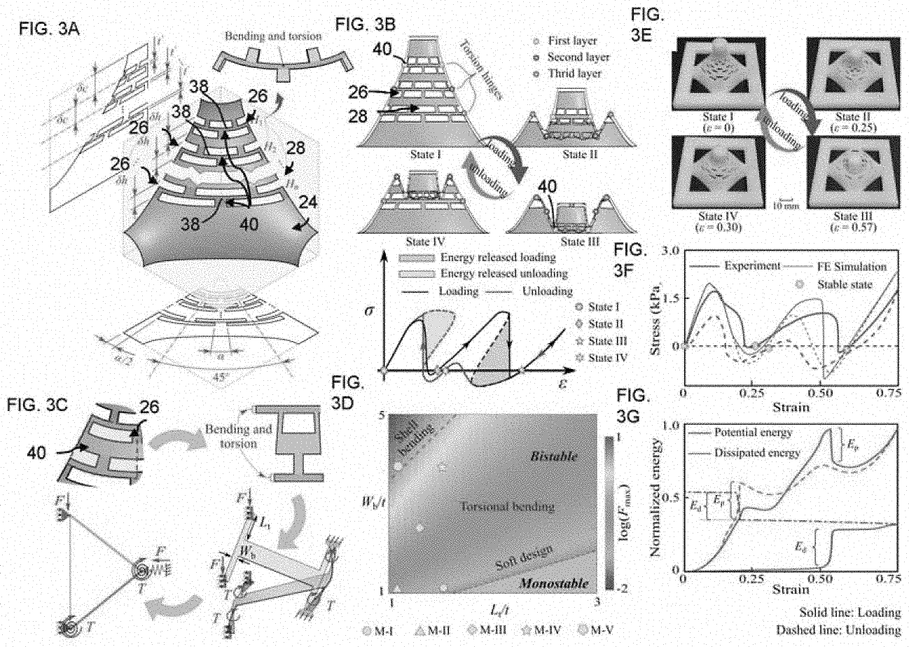

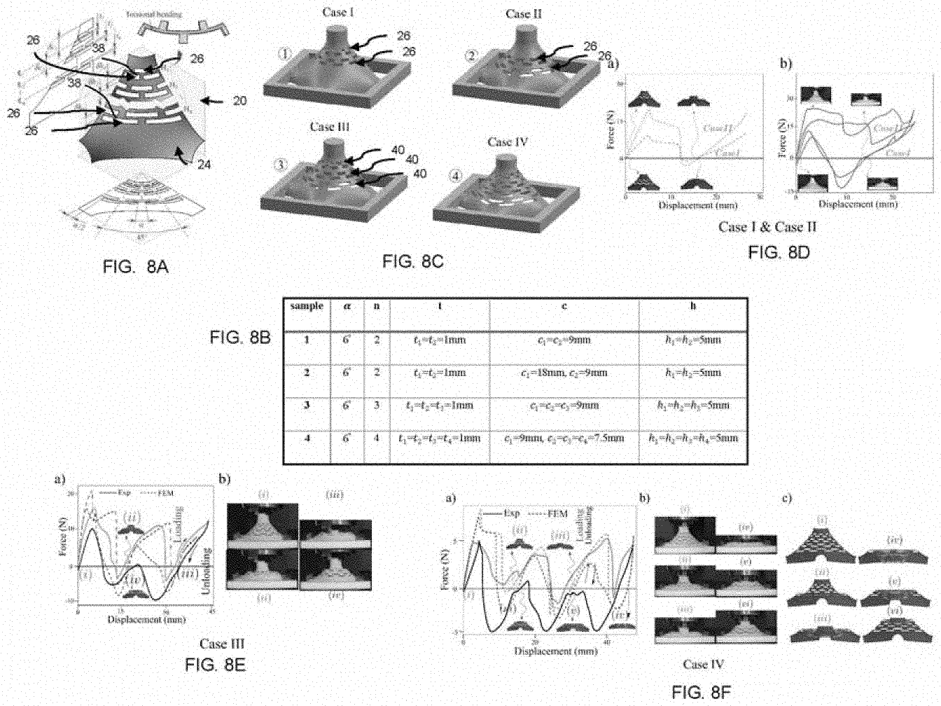

Even though the assembly of perforated shellular having bistable snapping motifs can facilitate designing multistable structures, the number of stable configurations will be limited since each perforated P shellular snapping motif possesses at most two stable states. Exploring perforation patterns that enable multistability of shellular snapping motifs can pave the way for designing highly reconfigurable multifunctional metamaterials for shape morphing applications. To realize multistable perforated shellulars, instead of adding multilayer circle or elliptical perforations, we create staggered multilayer rectangular perforations 26 on the shellular surface. FIG. 3A shows perforation patterns on one eighth of a shell 24 of P shellular surface with f as 0.8, where the pink area represents a single staggered layer, characterized by projected layer height (δh), projected layer distance (δc), the projected height (t′) of circumferential beam (pink part in top right inset), and radial beam (yellow part in the top right inset) spacing angle α. Referring to FIGS. 3A and 8A, a section 38 of the shell 24 extending between adjacent staggered perforations 26 defines a hinge 40 about which the shell 24 bends and twists between different stable structural states. The shell 24 can also bend and twist between unstable snapthrough structural states. Different from the previous compression—bending bistable mechanism in single perforated shellulars (FIG. 1A), the induced bistability of each staggered layer arises mainly from the counteraction between bending and torsion force of the flexible circumferential beam of staggered perforation pattern. Due to the high rigidity of rings connecting the neighboring staggered layers, the majority of the generated torsion and bending can be limited to one staggered layer to keep the structural instability localized in one specific staggered layer at a time, leading to a layer-by-layer multistable behavior when multiple staggered perforations are created on the shellular surface. Since the bistability of each staggered layer is generally decoupled from the rest of the layers, creating n-layer staggered perforations 26 on the surface of P shellular snapping motif can results in a maximum of 2ⁿ⁻¹ stable states during loading and unloading. Owing to the narrow flexible regions in staggered perforations, P shellular surfaces with small level set constants is not preferred for multistable design. Different combinations of t′ and a, which determine the bending and torsion stiffness of the flexible circumferential beams, are analyzed through numerical simulation and experimentation on 3D printed samples. In specific, five different structures, i.e. t′=0.5 mm and α=6° (Sample M-I), t′=0.5 mm and α=18° (sample M-II), t′=1 mm and α=10° (sample M-III), t′=1.5 mm and α=6° (sample M-IV), and t′=1.5 mm and α=18° (sample M-V) are involved and each of them is 3D printed with three replicates. All these five samples include three perforation layers and share the same level set constant (f=0.8), P shellular size (2S=50 mm), shell thickness (t=1 mm), layer height (δh=3 mm), and layer distance (δc=4.5 mm). Similar to the bistable shellular with elliptic perforations in FIG. 1D, a solid frame with a width of 10 mm and two solid cylinder bars with the height of 10 mm is used to constrain four sides, and top and bottom surfaces of the staggered perforation snapping motif, respectively.

As presented in FIG. 3B, apart from the initial state, the half-cell shellular with a three-layer staggered perforation 26 would exhibit at most another three stable states, caused by the bending and torsional deformation of the flexible circumferential beams defined in sections 38. In addition, snap-back behavior is observed from the loading and unloading stress-strain curves, indicated by dashed lines. It is noted that these dashed lines are inaccessible from conventional implicit dynamic analysis, and is determined through arc-length method and using shell elements for perforated shellulars. The hinge 40 of the multistable shellular with staggered perforation 26 consists of flexible circumferential beam and a relatively rigid inclined plate (see FIG. 3C). Upon high compressive strain, the counteraction between the downward bending and upward torsion reaction forces of the flexible beam can lead to a new stable configuration. Therefore, flexible beam length, Lₜ, and width, Wₜ, are two key parameters on designing the multistable shellulars with staggered perforation.

Based on the proposed spring model and relationship between geometrical parameters and structural properties, the contour of normalized snapping force, Fₘₐₓ, with respect to flexible beam length, Lₜ, and width, Wₜ, is presented in FIG. 3D. An increase of beam length Lₜ and a decrease of beam width Wₜ contribute to a smaller snapping force and weakening the bistability, indicated by the monostable snap-through domain with combination of large Lₜ and small W and soft design region featured by small snapping force in the bistable snap-through domain. This is because of the inverse relation of the bending and torsional stiffness Lₜ² and Wₜ, respectively. Accordingly, increasing beam length Lₜ has a dominant effect on decreasing bending stiffness, leading to monotonic snap-through behavior in the staggered perforation layers of shellular. Alternatively, since the bending stiffness is directly proportional to the cubic of the beam width Wₜ opposed to the torsional stiffness that is directly proportional with beam width Wₜ, decreasing the beam width Wₜ drastically weaken the bending stiffness. Therefore, sample M-V exhibits the strongest bistability, while sample M-I is in the vicinity of monostable snap-through domain.

FIG. 3E shows four stable configurations of 3D printed sample M-II, including three non-initial stable states. In displacement-control experiment, the dashed lines presented in FIG. 3B are inaccessible and two sudden drops in the stress-strain curve (at ε=0.23 and ε=0.55) are observed in FIG. 3F due to the snap-back behavior. The close agreement between experimental and FE simulation results validates the accuracy of our numerical simulation and theoretical analysis. The sudden shape changing caused by the snap-back instability of perforated shellulars leads to energy dissipation (Eₚ in FIG. 3G) which is converted into kinetic energy and finally internal thermal energy. The dissipated energy versus strain clearly demonstrates the snap-back induced energy dissipation (E_{d} in FIG. 3G) that contributes to most of the damped energy during loading and unloading of metamaterials and is desirable for developing reusable energy-absorbers.

To have a better understanding on the influence of geometrical parameters on the structural multistability, FIG. 4A presents the number of stable configurations of the five 3D printed staggered perforated P shellular snapping motifs. Increasing the circumferential angle α and decreasing the flexible beam height t′ lead to the maximum number of stability, i.e. 4 stable configurations found in sample M-II. In specific, sample M-I misses the stable state II in FIG. 3B while sample M-II exhibits all the four representative stable states. For the remaining samples M-III, M-IV, and M-V with three stable states, the loading and unloading deformation patterns are symmetrical, where state IV in FIG. 3B is replaced by stable state II during unloading.

Referring to FIG. 4B, a comprehensive parametric study on the multistable behavior of staggered perforated shellulars by FE simulation is conducted and number of stable states (contour shown on the left), maximum snap-back induced energy dissipation (contour shown in the middle)during loading and unloading, and total snap-back induced energy dissipation during cyclic loading (hysteresis) (contour shown on the right), are presented in FIG. 4B. It is noted that apart from sample M-IV, experimental observations on the number of stable configurations presented in FIG. 4A for four 3D printed samples are in agreement with FE simulation predictions. The discrepancy between the number of stable states observed from experimental (three stable states) and numerical anticipation (one stable state) in M-IV sample is because the frictional forces arising from the self-contact of the deformed shellular provide extra forces that hold the shellular at unanticipated stable states. However, the self-contact is not observed in the FE simulation, which might be due to the difference between the as-designed and SLS 3D printed as-built samples. To assess the snap-back induced energy dissipation, the maximum and total energy dissipations presented in FIG. 4B are normalized by the corresponding values of a snapping motif with α=18° and t′=0.1 mm. Generally, both contours share similar trend as the snapping force in spring model (FIG. 3D), where increasing a and t′ results in higher dissipated snap-back energy dissipation and snapping force.

By tailoring the perforation patterns on the flexible region of shellulars along one direction, we have accomplished unidirectional multistability in perforated shellular metamaterials. Since P shellulars have mutually independent flexible regions in three orthogonal orientations, one stimulating question is whether we can realize multidirectional multistability in perforated shellulars by patterning the shell surface by the staggered perforations orchestrated on all three directions. Here, the perforation pattern introduced in FIG. 3A is designed in all six flexible regions of P shellullars. In addition, in order to achieve multidirectional multistability, the solid frame in FIG. 4A is removed. To corroborate the validity of this multidirectional multistable design, FIG. 4C initially shows its stress-strain curves under uniaxial tension and compression tests. During tension, besides the initial state (i), four other stable states are observed, twice of the stable states found in half unit cell, and approve the multistability of the designed multidirectional perforated shellular. In specific, as presented in the stable configurations, the upper two perforation layers first switch to two stable states followed by the shape changing of bottom two layers. Shape morphing of multidirectional multistable perforated shellular leads to noticeable volume change (relative volume Vᵣ varies from 0.63 for state (i) to 1 for state (v)). Opposed to tension, during compression, only part of the unit cell restore to its original state and further deformation is needed to ensure the full recoverability of the multidirectional shellulars. It is noted that self-contact is observed during the cyclic tension-compression; this behavior is considered in FE simulation by assigning a frictional factor to the constitutive solid material. The good agreement between experimental and FE (with contact) results proves the accuracy of our numerical model. Apart from the snap-back induced energy dissipation, the self-contact behavior imparts a new mechanism to lock the configuration in stable configurations and enhance the snapping force required for triggering new stable states and to dissipate a higher level of energy, i.e. enclosed by two FE (with and without contact) curves. The shape morphing of the multidirectional multistable perforated shellular unit cell, with possible applications as a building block for developing soft and load-bearable robotic muscles or constructing impact energy absorbers, is presented in FIG. 4D. FIG. 4D shows a unit cell 22 in selected stable states obtained from the snapping motif 28 defined on the shell 24. In the shell-based material 20 presented in FIG. 4D, the shell 24 has multilayer staggered perforations 26 extending along orthogonal directions 1, 2 and 3. More particularly, the snapping motif 28 defined by the multilayer staggered perforations 26 is reproduced on the shell 24 using rotation transformations about directions 1, 2 and 3. The perforated motifs of this unit cell 22 along the orthogonal directions 1, 2 and 3 can be independently transformed into up to four stable configurations during tension and compression. The 3D printed shellular 20 in FIG. 4D presents about 75% reduction in the volume of unit cell when is morphed from the initial stable state to the most compact stable state. FIG. 4E demonstrates the load bearability of a multistable perforated shellular metamaterial comprised of 3×1×1 unit cells at seven representative stable configurations at which 1 kg weight is added at the bottom of the shellular metamaterial, that remains at stable states under the applied tensile load. To further corroborate that our designed perforated shellular unit cell can be tessellated in three directions and be used to construct materials, FIG. 4F presents five representative stable states of a 3D printed 3×3×3 perforated shellular metamaterial 20 including unit cells 22 each having a shell 24 as described with reference to FIG. 4D. The multistability along the three directions still can be realized in each direction, decoupled from the others, after tessellation of unit cells. The fully packed stable state demonstrates close to 25% of the volume of the fully unpacked one.

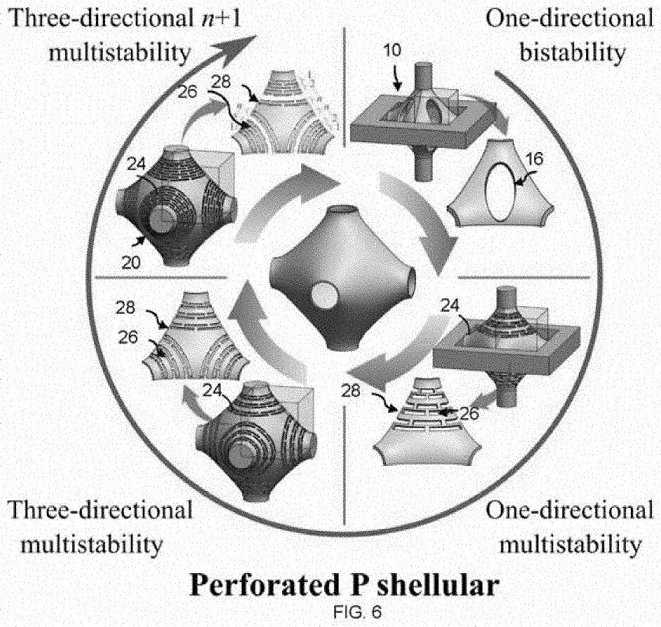

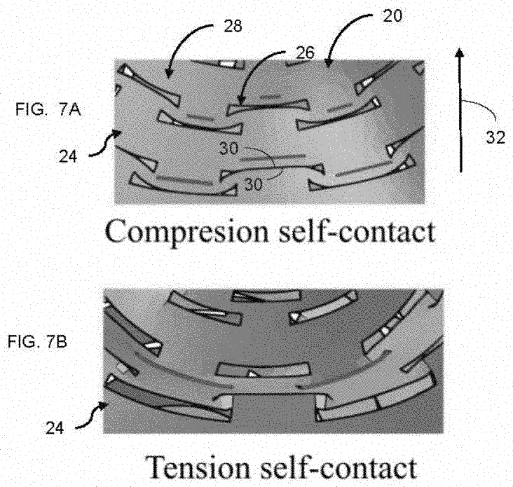

FIG. 4F shows an example of a type of shell network 60 including deterministic, periodic shell-based material 20 including unit cells 22 each including a curved shell 24. Each shell 24 has multilayer staggered perforations 26 defining a snapping motif 28 on the shell 24, as best seen in FIG. 6. The perforations 26 are rectangular perforations. The number of structural stable states is based on the snapping motif 28 and the number of staggered perforation layers introduced in each snapping motif 28 defined on the shell 24. In this example, the maximum number of stable states corresponds to 2ⁿ⁻¹ with n-layer perforations. Referring to FIGS. 7A and 7B, the portions of the shell 24 defining the long sides 30 of the rectangular perforations 26 contact with one another in response to the shell-based material 20 supporting a predetermined compression load in a direction represented by arrow 32 being orthogonal to the long sides 30.

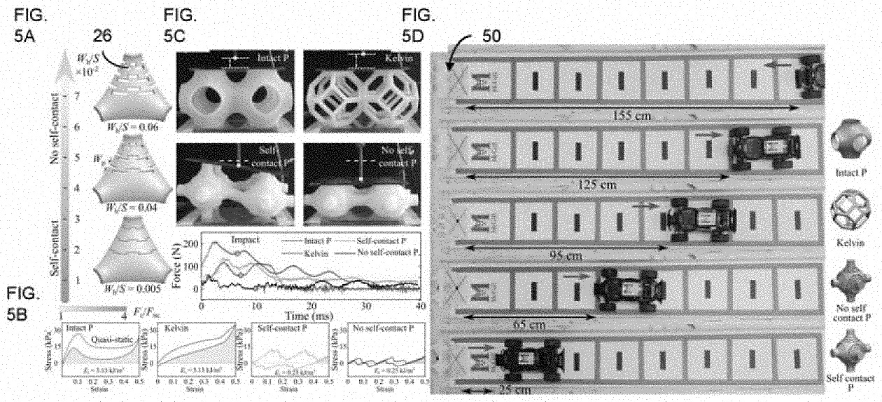

In order to study the absorbed/dissipated and stored energy properties of multistable perforated P shellular materials, FIGS. 5A-5D demonstrates their performance under quasi-static and impact tests. FIG. 5A presents a relationship between the non-dimensional perforation width (Wₕ/S) and perforation-induced self-contact, quantified by the ratio of numerical reaction force F_{c} (when perforation penetration is restricted during loading/unloading—self-contact) and F_{nc} (when perforation penetration is allowed—no self-contact). In other words, no self-contact means that the long sides of each rectangular perforation 26 remain spaced apart from one another when the shellular materials is subjected to load. The lower perforation width, the higher the reaction force ratio, which leads to enhanced energy dissipation and increased maximum reaction force applied by multilayer perforated P shellular to the loading nose or impactor.

FIG. 5B presents the quasi-static loading (compression) and unloading (tension) stress-strain curves of 2×2×1 self-contact (Wₕ/S=0.04) and no self-contact (Wₕ/S=0.06) multilayer perforated P shellular materials. Intact P shellular (f=0) and Kelvin cell based materials with 0.04 relative density and 160×160×80 mm dimension, the same as the corresponding values for multilayer shellular samples, are considered for the sake of material performance comparison. Multilayer staggered perforations convert the stiff monostable intact P shellular to a less stiff multistable perforated P shellular. The shell surface contact in the self-contact multilayer perforated P shellular materials enhances the reduced stiffness and strength and enhances energy absorption and dissipation. In contrast to the other samples, Kelvin-based cellular materials present a monotonous stress-strain curve. The area under the stress-strain curve in loading determines absorbed energy by material, while the enclosed area between the loading and unloading curves identifies dissipation energy. The shaded area below the unloading curve, till the nearest stable configuration, indicates the returned energy density Eᵣ, which is released to the system upon removal of the external load. Compared to intact P shellular (Eᵣ=3.13 kJ/m³) and Kelvin (Eᵣ=5.13 kJ/m³), most absorbed energy is trapped in multistable perforated shellulars, leading to a lower returned energy Eᵣ=0.25 kJ/m³ for both perforated shellular with and without self-contact. The reduced returned energy plays an important role in developing dampers (e.g. helmet and car bumper) that safely protect human or goods against impact.

FIG. 5C shows the drop weight impact test results on the abovementioned 3D printed samples, sandwiched between two plexiglass sheets and impacted by a 917.8 g dropped from 81 mm height (0.73 J impact energy). Intact P shellular materials shows the highest impact peak force, while no self-contact P shellular metamaterials imposes the lowest impact force (around 50 N). The shell surface contact in the self-contact P shellular metamaterial increases the impact force to 120N, similar to the 3D printed Kelvin sample. Due to the higher returned energy, after impact on the intact P shellular and Kelvin samples, the impactor rebounds significantly, opposed to the multistable multilayer perforated shellular metamaterials that stops the impactor immediately after the impact phenomenon. We also conduct an electric car impact test on these materials where the car starts to move from a 155 cm distance prior to the collision to the 3D printed dampers 50. As illustrated in FIG. 5D, after the impact, the electric car rebounds backward and finally stops at distances (e.g. 125 cm for intact P shellular and 25 cm for self-contact perforated P shellular metamaterials) depending on the returned energy of the cellular/shellular materials forming each one of the dampers 50.

Referring to FIG. 6, programmable multidirectional multistable shellular metamaterials are developed here by adding perforations on the P shellular surface. The technique might be expandable to other surfaces (including other TPMS) if their intact surface demonstrates snap-through behavior under compression. A half cell with elliptical perforations can lead to a bistable shellular snapping motif, while n-layer staggered perforations (n hinges) can contribute to a maximum of 2ⁿ⁻¹ stable states of a perforated snapping motif. Independent three directional multistable perforated shellulars are demonstrated using rotation transformations of a staggered perforated shellular snapping motif 28 about the three orthogonal coordinate directions.

In summary and referring to FIG. 6, we have developed a novel class of P shellular metamaterial, which can be one/two/three-directional multistable, deployable, programmable, and reusable under both tension and compression, enabled by a delicate and systematic design of the perforation patterns. The designed reconfigurable metamaterials also share the unique traits of shellular materials, such as high surface area, stiffness, and energy absorption. Two perforation design strategies are introduced and the associated mechanical and stability properties of the perforated shellulars are analyzed by theoretical mechanics models, FE simulations, and mechanical testing on SLS 3D printed samples. The first strategy realizes bistable shellulars 10 by introducing elliptical perforations 16 (FIGS. 1A and 1D), where the bistability arises from the balance between compression-induced buckling and bending of flexible parts. The mechanical responses of these perforated shellular structures can be controlled by tuning the geometrical parameters of the underlying shell and its perforation, while the deformation sequence of their stacked assembly can be programmed by tuning the snapping force of each shellular layer. In the second strategy, a multistable shellular snapping motif 28 is developed via multilayer staggered perforations 26 (FIGS. 3A to 3C). The bending-torsional hinges 40, imparted by staggered perforations 26 in each layer, contribute to the overall multistability of perforated shellular metamaterials 20. With n-layer staggered perforations 26 (n hinges 40), maximum 2ⁿ⁻¹ stable states can be achieved on each shellular motif 28, offering a new paradigm for realization of desired number of stable configurations in shell-like mechanical metamaterials. Using rationally designed multistable snapping motifs 28 with staggered perforation 26, we have demonstrated how multidirectional multistable shellulars 20 with load-bearable stable configurations can be attained. Compared to the existing bistable metamaterials, our developed and prototyped multistable shell-like metamaterials 20 are based on multistable perforated shellular snapping motifs 28 (rather than bistable truss snapping motifs), and damp energy through a combined snap-back and self-contact induced energy dissipation mechanisms. Experiments confirm the load-bearability of multistable states of perforated P shellulars 20 under tension and low-velocity impact tests through drop weights and moving an electric car corroborate their programmable energy damping performance. We believe that our novel designed perforated shellular metamaterials 10, 20 (FIG. 6) can serve as a next generation of multifunctional metamaterials with versatile applications, spanning from the reusable energy absorbers/dampers and programmable wave filters to reconfigurable and intelligent robotic arms and microelectromechanical systems.

Referring now to FIGS. 8A to 8E, we showed that shellular perforated multistable metamaterials 20 can be programmed to reveal the desired properties and the number of stable configurations (FIG. 8A). The number of configurations and sequence of their snapping are programmable with instability forces, which are tunable with geometrical parameters. This programmability facilitates tailoring stiffness, strength, energy absorption, and shape morphing of shell-like materials and structures. In this regard, we designed four samples (FIG. 8B) with geometrical parameters shown in FIG. 8B.

Case I and Case II of FIG. 8C have two layers of perforations, which make two hinges and one foldable layer in between. By comparing these two samples, perforation at the top part have higher instability forces (both in compression and tension) (FIG. 8D). By combining cases I and II, case III is designed with three layers of hinges 40 and two foldable layers. These instability forces in each design helped us to achieve four different configurations. The deformation sequences are also based on the order of the instability forces. For example, the lower layer has lower instability forces, and always snaps first, as seen in FIG. 8E.

Finally, by designing case IV we showed that we can increase the number of stable configurations from two in cases I and II to four in case III and six in case IV, designed with four layers of hinges 40 and three foldable layers (FIG. 8F). The increasing layer of perforation based on the order of instability forces in each cell leads to predictable deformation sequences from bottom to top in compression and again from bottom to top in tension. Moreover, by adding more layers, the number of times that snap-back-induced energy dissipation happens increases (from 0 in cases I and II to six in case IV).

As can be understood, the examples described above and illustrated are intended to be exemplary only. The scope is indicated by the appended claims.

What is claimed is:

1. A shell-based material comprising:
a plurality of interconnected unit cells, each unit cell including a continuously curved shell, the shell having at least one perforation defining a snapping motif on the shell,
wherein the shell-based material has a predetermined number of structural states based on the snapping motif defined on the shell of the unit cell and on the at least one perforation defined on the shell, the predetermined number of structural states including a first structural state, and a second structural state being different from the first structural state.

2. The shell-based material of claim 1, wherein each shell has a configuration of Schwarz P of alternative level set constants.

3. The shell-based material of claim 1, wherein the at least one perforation includes an elliptical perforation.

4. The shell-based material of claim 3, wherein at least one of the unit cells is configured for supporting a predetermined load in a load direction, and a major diameter of the elliptical perforation extends along the load direction.

5. The shell-based material of claim 1, wherein the at least one perforation includes a plurality of multilayer staggered perforations.

6. The shell-based material of claim 5, wherein the predetermined number of structural states includes 2\hat{ }(n−1) structural states, wherein n corresponds to a number of layers of the multilayer staggered perforations.

7. The shell-based material of claim 5, wherein the multilayer staggered perforations include rectangular perforations.

8. The shell-based material of claim 7, wherein portions of the shell defining long sides of at least some of the rectangular perforations contact one another in response to the shell-based material supporting a predetermined compression load in a direction orthogonal to the long sides of the rectangular perforations.

9. The shell-based material of claim 7, wherein portions of the shell defining long sides of at least some of the rectangular perforations remain spaced apart from one another in response to the shell-based material supporting a predetermined compression load in a direction orthogonal to the long sides of the rectangular perforations.

10. The shell-based material of claim 5, wherein a section of the shell extending between adjacent staggered perforations defines a hinge, and the shell bends and twists about the hinge between the first structural state and the second structural state, the first and second structural states being consecutive structural states.

11. The shell-based material of claim 5, wherein the second structural state corresponds to a snap-back behavior of the unit cell.

12. The shell-based material of claim 5, wherein the second structural state corresponds to a snap-through behavior of the unit cell.

13. The shell-based material of claim 1, wherein the at least one perforation includes a first perforation extending along a first direction, and a second perforation extending along a second direction orthogonal to the first direction.

14. The shell-based material of claim 13, wherein the snapping motif is reproduced on the shell using rotation transformations about the first and second directions.

15. The shell-based material of claim 13, wherein the shell-based material has the first structural state and the second structural state along the first direction, and further has
a third structural state being different from the first and second structural states, and
a fourth structural state being different from the first, second and third structural states,
the third and fourth structural states being along the second direction.

16. The shell-based material of claim 13, wherein the at least one perforation further includes a third perforation extending along a third direction orthogonal to the first and second directions.

17. The shell-based material of claim 1, wherein the shell-based material is formed of at least one of a thermoplastic polyurethane, a rubber-based material and a silicon-based material.

18. The shell-based material of claim 1, wherein at least one of the first and second structural state is a stable structural state.

19. A damper comprising the shell-based material of claim 1.

20. A shell network comprising the shell-based material of claim 1.
